(19) United States
(12) Patent Application Publication
(10) Pub. No.: US 2015/0372984 A1
(43) Pub. Date: Dec. 24, 2015

(54) PROTECTING AGAINST SNIFFING BASED ON INTERVALS BETWEEN USER INPUT SIGNALS

(71) Applicants: Gary Kacmarcik, Bothell, WA (US); Albert Wong, Seattle, WA (US)

(72) Inventors: Gary Kacmarcik, Bothell, WA (US); Albert Wong, Seattle, WA (US)

(73) Assignee: GOOGLE INC., Mountain View, CA (US)

(21) Appl. No.: 13/301,511

(22) Filed: Nov. 21, 2011

(51) Int. Cl. H04L 29/06

(52) U.S. Cl. CPC H04L 63/04; H04L 63/0428; H04L 63/164

(57) ABSTRACT

Various example embodiments are disclosed. According to an example embodiment, a non-transitory computer-readable storage medium may include instructions stored thereon. When executed, the instructions may cause a client computing device to perform at least establishing a peer-to-peer connection with a host computing device, receiving multiple user input signals from a user of the client computing device, generating a packet, the packet including representations based on at least two of the user input signals, and sending the packet to the host computing device via the peer-to-peer connection.

### TECHNICAL FIELD

This description relates to remote computing.

### BACKGROUND

Client computers may provide user input, including keystrokes, to host computers via a network, such as the Internet. The host computer may provide output back to the client computer based on the received input. In one example, the user input may appear to control the host computer, by the user input in the client computer controlling a virtual screen and applications on the host computer, and the host computer sending a visual and/or video output of the screen and applications to the client computer. An attacker or hacker may sniff the packets which represent the keystrokes, and attempt to determine which keystrokes the packets represent based on time intervals between the keystrokes.

### SUMMARY

According to one general aspect, a non-transitory computer-readable storage medium may include instructions stored thereon. When executed, the instructions may cause a client computing device to perform at least establishing a peer-to-peer connection with a host computing device, receiving multiple user input signals from a user of the client computing device, generating a packet, the packet including representations based on at least two of the user input signals, and sending the packet to the host computing device via the peer-to-peer connection.

According to one general aspect, a non-transitory computer-readable storage medium may include instructions stored thereon. When executed, the instructions may cause a client computing device to perform at least establishing a peer-to-peer connection with a host computing device, receiving multiple user input signals from a user of the client computing device, storing representations of the multiple user input signals, generating multiple packets, the multiple packets including the representations of the multiple user input signals, and sending, via the peer-to-peer connection, the multiple packets to the host computing device with intervals between sending times of the multiple packets which are different than intervals between receiving the multiple user input signals from the user.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram showing a client computing device in communication with a host computing device via a network.

FIG. 2A is a diagram showing keystrokes entered into the client computing device and packets sent to the host computing device in an example in which random changes are made to the intervals between the packets.

FIG. 2B is a diagram showing keystrokes entered into the client computing device and packets sent to the host computing device in an example in which the intervals between the packets are modified toward an average value.

FIG. 2C is a diagram showing keystrokes entered into the client computing device and packets sent to the host computing device in an example in which the intervals between sending the packets are all a same average value.

FIG. 2D is a diagram showing keystrokes entered into the client computing device and packets sent to the host computing device in an example in which some of the keystrokes are batched into packets.

FIG. 2E is a diagram showing keystrokes entered into the client computing device and packets sent to the host computing device in an example in which the client computing device sends batched packets at regular intervals.

FIG. 2F is a diagram showing keystrokes entered into the client computing device and packets sent to the host computing device in an example in which the client computing device sends fake or dummy packets to the host computing device.

FIG. 3A is a diagram showing an unencrypted packet and an encrypted payload according to an example embodiment.

FIG. 3B is a diagram showing an unencrypted payload according to an example embodiment.

FIG. 3C is a diagram showing an unencrypted payload with salt according to an example embodiment.

FIG. 3D is a diagram showing the unencrypted payload in an example in which two characters have been batched into a single unencrypted packet.

FIG. 3E is a diagram showing an unencrypted payload of a fake event or dummy packet according to an example embodiment.

FIG. 4 is a flowchart showing a method according to an example embodiment.

FIG. 5 is a flowchart showing a method according to another example embodiment.

FIG. 6 shows an example of a generic computer device and a generic mobile computer device, which may be used with the techniques described here.

### DETAILED DESCRIPTION

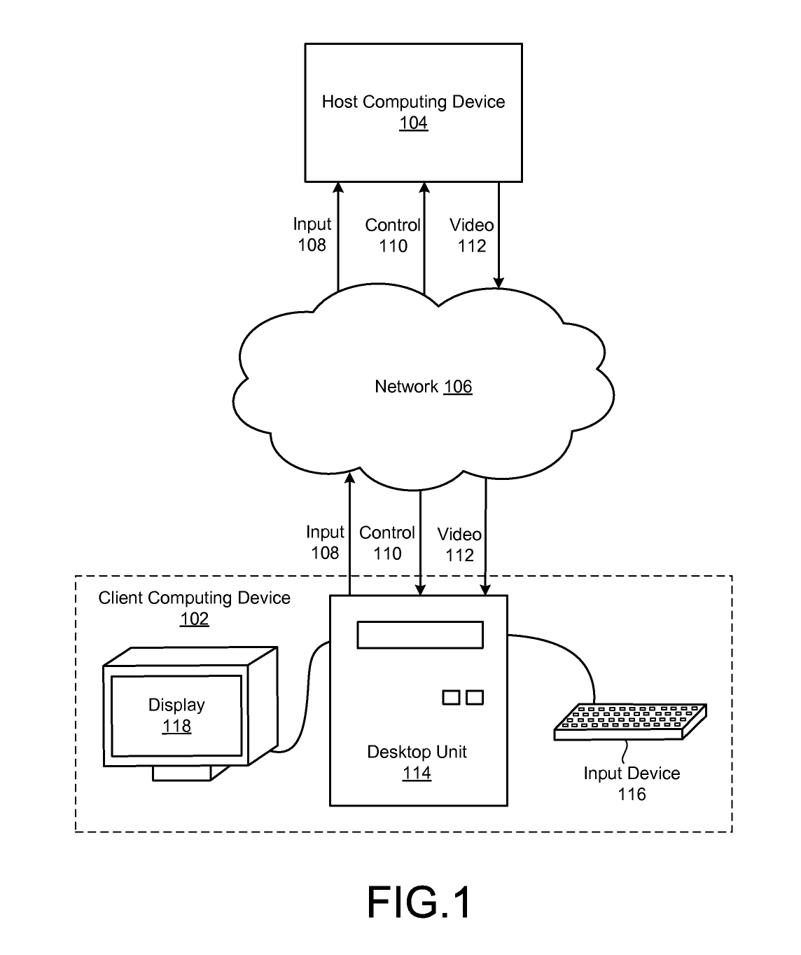

FIG. 1 is a diagram showing a client computing device 102 in communication with a host computing device 104. The client computing device 102 may communicate with the host computing device 104 via a network 106. The network 106 may include, for example, the Internet, a local area network (LAN), a wide area network (WAN), a wireless local area network (WLAN), or any network via which computing devices may communicate, such as by sending and receiving packets to and from each other.

The host computing device 104 may have greater computing resources than the client computing device 102. The host computing device 104 may include, for example, a desktop or personal computer or a server, and the client computing device 102 may include, for example, a desktop or personal computer, a laptop or notebook computer, a mobile phone or smartphone, a tablet computer, a thin client, or other computing device. The client computing device 102 may control operations performed on the host computing device 104.

The client computing device 102 may be logged into the host computing device 104 via, for example, a remote desktop connection or other peer-to-peer connection. The client computing device 102 and host computing device 104 may communicate according to Internet Protocol (IP) or another protocol, sending and receiving packets to and from each other via the network 106, for example. The client computing device 102 may receive input signals, such as keystrokes and/or mouse movements, from a user (or representations thereof), and send the input (and/or representations of the input), such as keystrokes and/or mouse movements, to the host computing device 104. The host computing device 104 may perform operations based on the received input from the client computing device 102, and send output back to the client computing device 102. The output sent by the host computing device 104 to the client computing device 102 may include representations of video and/or visual output, as non-limiting examples.

Based on the exchange of input and output between the client computing device 102 and the host computing device 104, the user of the client computing device 102 may be virtually using, controlling, or working on the host computing device 104. The client computing device 102 may have established a secure connection with the host computing device 104 via the network 106. The client computing device 102 may, for example, have facilitated the entry of a username and password by the user to the host computing device 104 via the network 106, such as by presenting a user interface to the user which includes a username field and a password field.

The client computing device 102 and host computing device 104 may communicate via encrypted packets. The client computing device 102 may store representations of keystrokes (or other user input signals) received from a user, and may generate packets which include representations of the received keystrokes, and send the packets to the host computing device 104. The packets may be encrypted by a symmetric or asymmetric key which may have been negotiated between the client computing device 102 and the host computing device 104 during login, and which an attacker may be unable to decipher. However, an attacker may attempt to determine which of the inputted keystrokes the packets represent based on intervals between sending the packets, thereby inferring intervals between the user typing the keys into the client computing device 102. For example, it may be habitual for many users, or a certain known user, to type certain keys quickly after other keys and other keystrokes more slowly after certain keys when typing a particular word or phrase. An attacker may attempt to utilize the timing information between keystrokes to determine which encrypted packets represent which keystrokes because the encrypted packets cannot be directly deciphered due to encryption, and thereby decipher the communications (e.g., the word or phrase) between the client computing device 102 and the host computing device 104.

As discussed above, the client computing device 102 and the host computing device 104 may be connected by a secure peer-to-peer connection. The client computing device 102 and host computing device 104 may have three communication channels, according to an example embodiment. The client computing device 102 may provide input 108 to the host computing device 104. The host computing device 104 may return video 112 (or a series of images) back to the client computing device 102. The video 112 may include compressed bitmaps and/or delta maps, as non-limiting examples. A control channel 110 may be used for two-way traffic between the client computing device 102 and host computing device 104, sending login information, maintaining the session information, and authenticating the user of the client computing device 102, as non-limiting examples.

In an example embodiment, the client computing device 102 may include a desktop unit 114 which may include a desktop computer, or may include a laptop computer or other processing system. The client computing device 102 may also include an input device 116, such as a keyboard and/or mouse. The client computing device 102 may also include a display 118 which may include, for example, an LCD display, a flat screen display, a plasma screen, or other electronic device capable of providing visual output to a user. While FIG. 1 shows the client computing device 102 made up of separate components, namely the desktop unit 114, input device 116, and display 118, the client computing device 102 may also be manufactured as a single device, such as a mobile phone or smartphone, a thin client, a laptop or notebook computer, or a tablet computer, according to example embodiments.

As discussed above, an attacker may attempt to determine and/or decipher the keystrokes inputted into the client computing device 102 based on inferring the timing intervals between the keystrokes from the intervals between the packets. In order to prevent the attacker from deciphering the keystrokes based on the intervals between the keystrokes, the client computing device 102 may alter the timing between sending the packets which include representations of the keystrokes (or other user input signals) so that the intervals between the sending times of the packets are different than the intervals between receiving the keystrokes from the user. The client computing device 102 may store and/or buffer the packets, which include representations of the received keystrokes, for sending to the host computing device 104 at the appropriate times.

The client computing device 102 may, for example, introduce random, pseudo-random, or non-random changes to the intervals between sending the different packets and/or delays between receiving the keystrokes (or other user input) and sending the packets, so that the intervals between sending the packets no longer conform to keystroke patterns that an attacker may be able to decipher. The client computing device 102 may, for example, change the delay between sending the packets. The client computing device 102 may introduce random delays to sending the packets, or may change the delays between sending the packets to make the delays more uniform, by creating a more even spacing or interval between the sending of the packets. The client computing device 102 may also batch representations of multiple keystrokes into a single packet. This changing of delays and/or batching of multiple keystrokes into a single packet may reduce the ability of the attacker to determine the keystrokes based on the intervals between the packets. The client computing device 102 may batch random numbers of keystrokes into a single packet, or may send packets at regular intervals, with the packets including representations of as many keystrokes as have been typed during the preceding interval.

The client computing device 102 may also introduce fake events, such as dummy packets, into the stream of packets sent to the host computing device 104 via the network 106. The client computing device 102 may, for example, send dummy packets or fake events to the host computing device 104 when no keystrokes are being typed or when there is a pause between keystrokes, thereby fooling an attacker into believing that these packets represented actual keystrokes.

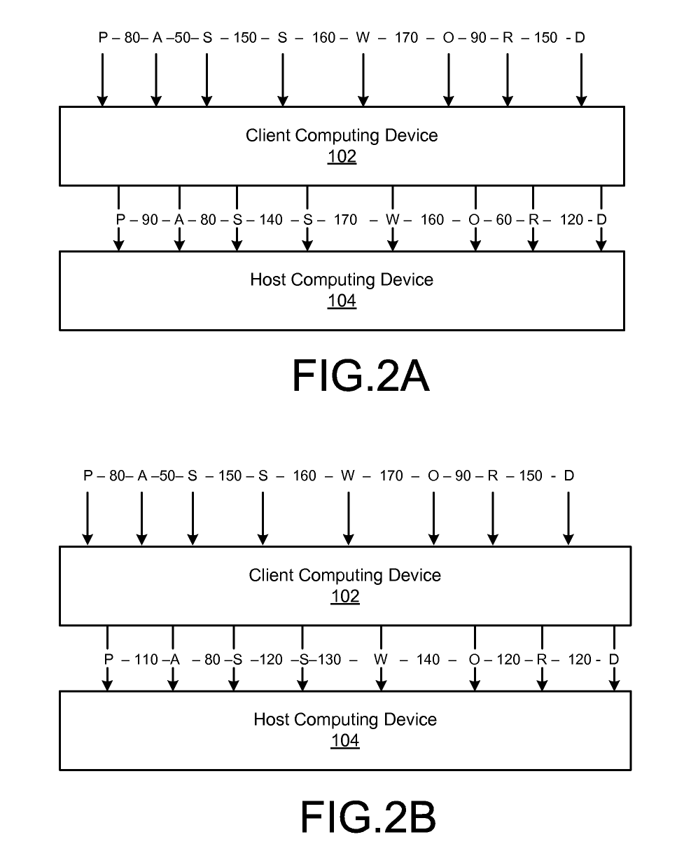

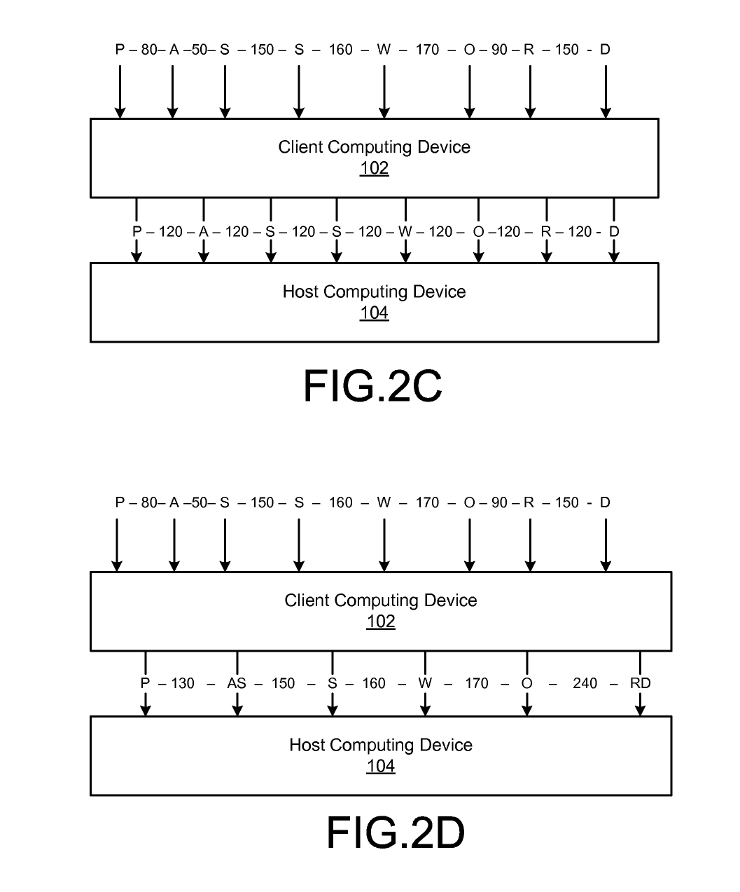

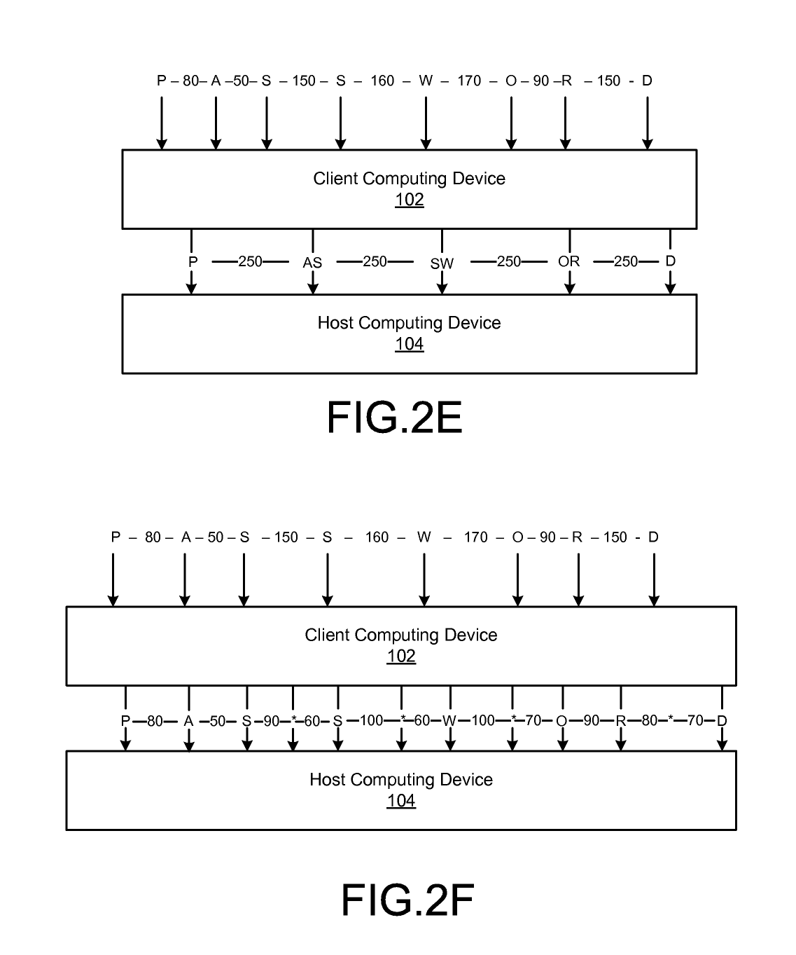

In FIGS. 2A-2F, an example will be used in which a user typed the word “password” into the client computing device 102. While this example is discussed with respect to “keystrokes”, it may also apply to other user input signals received by the client computing device 102. For example, a keyboard (or other input device 116) may receive keystrokes from a user, generate electronic signals representing the keystrokes inputted by the user, and send the electronic signals to the desktop 114 of the client computing device 102. The client computing device 102 may receive the user input in the form of electronic (or other) signals representing the keystrokes (or other form of input, such as touching characters on a touchscreen) and/or mouse movements. In each of these examples, the timing or intervals between the keystrokes, or typing of the letters or characters, is the same. In these examples, the interval between typing the letter “p” and typing the letter “a” is 80 milliseconds. The interval between typing the letter “a” and typing the first “s” is 50 milliseconds. The interval between typing the first “s” and typing the second “s” is 150 milliseconds. The interval between typing the second “s” and typing the “w” is 160 milliseconds. The interval between typing the “w” and typing the “o” is 170 milliseconds. The interval between typing the “o” and typing the “r” is 90 milliseconds, and the interval between typing the “r” and typing the “d” is 150 milliseconds, as shown in FIGS. 2A-2F. This is merely an example, and the word, “password,” could be typed with different intervals between the letters.

As discussed above, if the client computing device 102 sent packets to the host computing device 104 with the same intervals between sending the packets as between receiving the keystrokes (or other user input signals), an attacker may be able to determine a probability, based on these intervals, that the word “password” had been typed, and thereby determine which letters each of the packets represented. This probability may be based on assumptions about the attackee or user, such as the keyboard being used and/or the language being typed. The attacker may use these assumptions to build a model based on general characteristics of users typing on the assumed keyboard and/or in the assumed language. Before discussing the changes in the delays or intervals between sending packets, a discussion will be made of the packets.

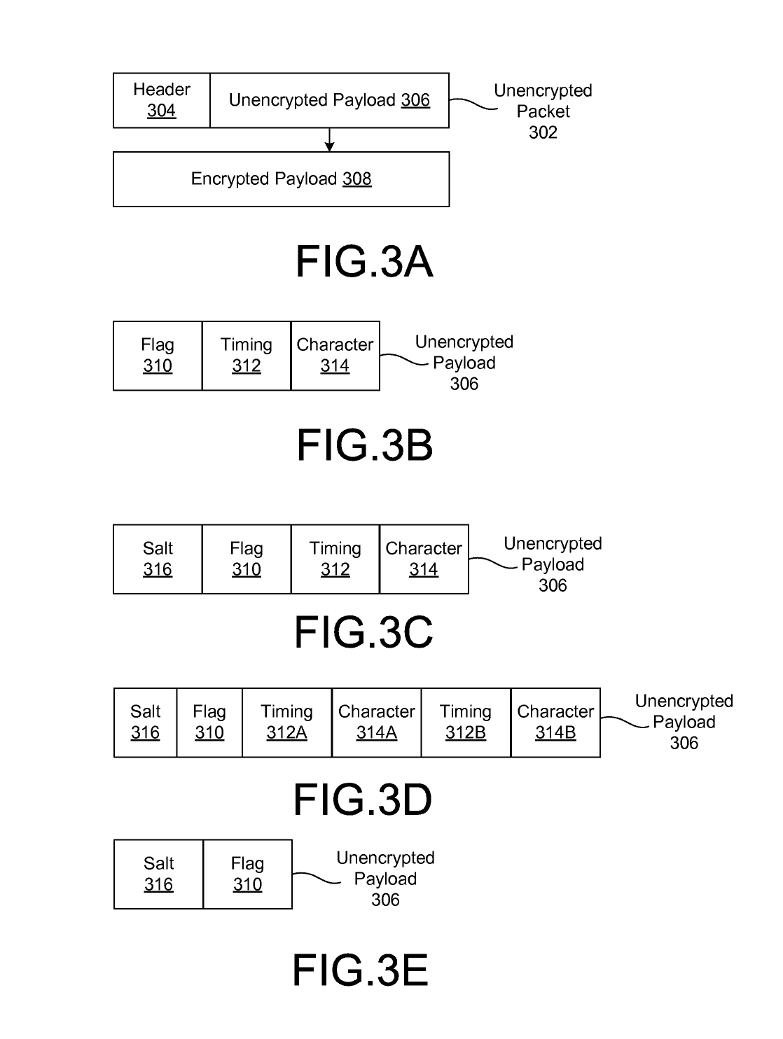

FIG. 3A is a diagram showing an unencrypted packet 302 and an encrypted payload 308 according to an example embodiment. The unencrypted packet 302 may include a header 304 and an unencrypted payload 306. The header 304 may include addressing information, such as a source address indicating an address (which may include an Internet Protocol (IP) address of the client computing device 102) and a destination address (which may include an IP address of the host computing device 104). The unencrypted payload 306 may include a representation of the keystroke (or other user input signal) typed into the client computing device 102. The unencrypted payload 306 may also include other information, discussed below with respect to FIGS. 3B-3E.

Before sending the packet to the host computing device 104, the client computing device 102 may encrypt the unencrypted payload 306 to generate the encrypted payload 308. The unencrypted payload 306 may have a variable length based on a number of keystrokes or characters included in the packet, but the encrypted payload 308 may have a fixed length, which may be greater than the length of the unencrypted payload 306. The fixed length of the encrypted payload 308 may reduce the ability of an attacker to determine a number of characters, or which characters, are included in the packet.

FIG. 3B is a diagram showing an unencrypted payload 306 according to an example embodiment. In this example, the unencrypted payload 306 may include a representation of a single character typed into the client computing device 102. The unencrypted payload 306 may include a flag 310 (or flag field) indicating whether the unencrypted payload 306 actually represents a keystroke (or other user input signal) that was typed into the client computing device 102, or whether the unencrypted packet 302 is merely a dummy packet introducing a fake event to fool an attacker. The unencrypted payload 306 may also include a timing field 312 which indicates a time at which the keystroke was entered into the client computing device 102. The timing field 312 may include a timestamp indicating a time of receipt, such as a time at which the keystroke was entered into the client computing device 102. The unencrypted payload 306 may also include a character field 314 which indicates the character which was typed into the client computing device 102. The character field 314 may include, for example, an ASCII representation of the character (and/or keystroke) typed into the client computing device 102.

The unencrypted payload 306 may also include salt to prevent an attacker from deciphering the encrypted payloads 308 based on frequency of appearance. FIG. 3C is a diagram showing an unencrypted payload 306 with salt according to an example embodiment. In this example, the unencrypted payload 306 may include the flag field 310, the timing field 312, and the character field 314 as discussed with respect to FIG. 3B. However, the unencrypted payload 306 shown in FIG. 3C may also include salt 316. The salt 316 may include random characters, numbers, symbols, or bits which will be ignored by the receiving device, such as the host computing device 104. It may be understood between the client computing device 102 and the host computing device 104 that a first sequence of characters, numbers, symbols, or bits will be ignored, namely the salt 316. While the salt 316 is shown at the beginning of the unencrypted payload 306 in FIG. 3C, the salt 316 may be included in any part of the unencrypted payload 306 so long as the location and length of the salt 316 is understood between the client computing device 102 and the host computing device 104. This location and length of the salt 316 may be negotiated during the logging in and authentication of the client computing device 102 to the host computing device 104, or may be an understood part of the communication protocol between the client computing device 102 and the host computing device 104, as non-limiting examples.

Returning to FIG. 3A, the unencrypted payload 306 may be encrypted into the encrypted payload 308. The unencrypted payload 306 may have a variable length depending on the number of keystrokes carried by the packet 302; however, the encrypted payload 308 may always have a same length. The encryption and decryption between the unencrypted payload 306 and the encrypted payload 308 may be one-to-one, meaning that each unencrypted payload 306 can lead to only one encrypted payload 308, and each encrypted payload 308 can lead to only one unencrypted payload 306, or may mean that each representation of an encrypted payload 308 can lead to only one unencrypted payload 306. Thus, if same keystrokes represented by the unencrypted payload 306 were represented by identical encrypted payloads 308, then an attacker could use a language model and letter frequencies to make informed guesses regarding the contents of the encrypted payload 308. However, the salt 316 shown in FIG. 3C (or even a timestamp or other random data) may prevent the attacker from determining the contents of the encrypted payload 308 by causing the encrypted payload 308 to look different even if the flag 310, timing 312 and character 314 fields of the unencrypted payload 306 are the same, based on the salt 316 being different.

Returning to FIGS. 2A-2F, the changing of the intervals between sending the packets from the intervals between receiving the keystrokes will be discussed. While the term, “keystrokes” is used herein, the changes may be made with respect to any user input signals, such as electronic representations of keyboard characters or mouse movements. FIG. 2A is a diagram showing keystrokes entered into the client computing device 102 and packets sent to the host computing device 104 in an example in which random changes are made to the delays and/or intervals between sending the packets. The changes may be random, generated by the processor randomly with each packet, or pseudorandom, using a lengthy sequence of numbers for the delay which will not be decipherable, but which are previously known to the client computing device 102.

In the example shown in FIG. 2A, the random changes are either increasing the interval between sent packets by ten, twenty, or thirty milliseconds, or decreasing the interval between dent packets or delay by ten, twenty, or thirty milliseconds. While delay between receiving the keystroke and sending the packet can actually only be increased, the delay may be apparently decreased by having a constant amount of delay between receiving the keystroke (or other user input signal) and sending the corresponding packet which is applied to each packet, and then subtracting the delay from that constant amount, or rather than adding the constant delay and then subtracting the random delay, the delays may be randomly set to be either 10, 20, 30, 40, 50, or 60 milliseconds between receiving the keystroke from the user and sending the packet, which includes the representation(s) of the keystroke, to the host computing device 104.

In the example shown in FIG. 2A, the delays between receiving a keystroke from the user into the client computing device 102 to sending the packet representing the keystroke to the host computing device 104 are increased, but the delays and associated intervals between receiving the keystrokes, represented by the arrows extending from the letters into the client computing device 102, and sending the packets which include the representations of the keystrokes (represented by the arrows extending from the client computing device 102 through the letters to the client computing device 104), may be changed. Thus, the interval between receiving the keystrokes of the “p” and the “a” has been increased from 80 milliseconds to 90 milliseconds. The interval between receiving the “a” keystroke and the first “s” keystroke has been increased from 50 milliseconds to 80 milliseconds. The interval between receiving the first “s” keystroke and the second “s” keystroke has been decreased from 150 milliseconds to 140 milliseconds. The interval between receiving the second “s” keystroke and the “w” keystroke has been increased from 160 milliseconds to 170 milliseconds. The interval between receiving the “w” keystroke and the “o” keystroke has been reduced from 170 milliseconds to 160 milliseconds. The interval between receiving the “o” keystroke and the “r” keystroke has been reduced from 90 milliseconds to 60 milliseconds, and the interval between receiving the “r” keystroke and the “d” keystroke has been reduced from 150 milliseconds to 120 milliseconds.

These random changes to the intervals between keystrokes may make it more difficult for an attacker to decipher which keystrokes were made based on the timing between the keystrokes. Additionally, while the timing of sending the packets has changed, the time stamps included in the packets with the representations of the keystrokes remain the same, so the host computing device 104 will still know the actual intervals between receiving the keystrokes. When the host computing device 104 sends the video 112 back to the client computing device 102, the video 112 may indicate the same intervals between keystrokes so that the user of the client computing device 102 will view the client computing device 102 as showing the keystrokes with the same intervals as were typed into the client computing device 102.

FIG. 2B is a diagram showing keystrokes entered into the client computing device and packets sent to the host computing device in an example in which the intervals between the packets are modified toward an average value. In this case, the average time between receiving keystrokes from the user typing the word, “password,” is approximately 120 milliseconds. In this example, to modify the intervals between sending the packets toward this average value of 120 milliseconds, the intervals which were less than 120 milliseconds were increased by 30 milliseconds, and the intervals which were greater than 120 milliseconds were reduced by 30 milliseconds. Thus, in this example, the interval between receiving the “p” keystroke and the “a” keystroke was increased from 80 milliseconds to 110 milliseconds. The interval between receiving the “a” keystroke and receiving the first “s” keystroke was increased from 50 milliseconds to 80 milliseconds. The interval between receiving the first “s” keystroke and the second “s” keystroke was reduced from 150 milliseconds to 120 milliseconds. The interval between receiving the second “s” keystroke and the “w” keystroke was reduced from 160 milliseconds to 130 milliseconds. The interval between receiving the “w” keystroke and the “o” keystroke was reduced from 170 milliseconds to 140 milliseconds. The interval between receiving the “o” keystroke and the “r” keystroke was increased from 90 milliseconds to 120 milliseconds, and the interval between receiving the “r” keystroke and the “d” keystroke was decreased from 150 milliseconds to 120 milliseconds. Thus, the information included in the differences in intervals between keystrokes has been reduced by averaging the intervals between the keystrokes, thereby reducing the ability of an attacker to determine which keystrokes were made.

FIG. 2C is a diagram showing keystrokes entered into the client computing device 102 and packets sent to the host computing device 104 in an example in which the intervals between sending the packets representing the keystrokes from the client computing device 102 to the host computing device 104 are changed to a same average value for all of the packets representing the keystrokes. The client computing device 102 may determine an average interval between receiving the keystrokes. The client computing device 102 may determine the average interval based on previously-typed words, or based on a current word, as non-limiting examples. Thus, in this example, the intervals between all of the keystrokes, namely, “p”, “a”, “s”, “s”, “w”, “o”, “r”, “d” was changed from their actual intervals to an average and/or uniform interval of about 120 milliseconds. This may eliminate all of the information regarding the intervals between the keystrokes, taking away information based upon which an attacker may decipher the keystrokes based on their intervals. Note that in these examples, the averaging of the intervals may be achieved by an increase in delay between receiving a keystroke and sending the corresponding packet, but the increase in delay between receiving the keystroke and sending the packet representing the keystroke should not exceed a threshold value. The threshold value should be determined in such a manner as to keep the latency or delay between the user entering the keystrokes and receiving the visual representation low enough so that the user will still see the representation of the keystroke without undue delay to interfere with the user experience.

FIG. 2D is a diagram showing keystrokes entered into the client computing device 102 and packets sent to the host computing device 104 in an example in which some of the keystrokes are batched into packets. In this example, the client computing device 102 may randomly batch either one or two keystrokes into a single packet. The client computing device 102 may randomly batch other numbers of keystrokes into the packets, such as one, two, three, four, five, or up to a hundred or more; the random number may have an equal probability of any number of keystrokes, or the time length of the window may be randomly determined, causing closely-typed keystrokes to be more likely to be batched together, according to various example embodiments.

FIG. 3D is a diagram showing the unencrypted payload 306 in an example in which representations of two characters have been batched into a single unencrypted packet 302. In this example, the unencrypted payload 306 may include the salt 316 which includes random characters to introduce difficulty in decrypting the encrypted payload 308. The flag 310 indicates that the packet 302 is a packet which actually represents one or more keystrokes, rather than simply a dummy packet or fake event designed to confuse an attacker. The unencrypted payload 306 also includes representations of two characters and their timing information. In this example, the unencrypted payload 306 may include a timing field 312A which includes a time stamp of a first batched keystroke, and a character field 314A which includes a representation of the character of the first keystroke. The unencrypted payload 306 may also include a timing field 312B which includes a time stamp of a second keystroke, and a character field 314B which includes a representation of a character of a second keystroke.

Returning to FIG. 2D, the character “p” may have been sent as a single keystroke in a packet, and may have been included in an unencrypted payload 306 as shown in FIG. 3C. The two characters, “a” and “s,” may have been included in a batched packet with the unencrypted payload 306 as shown in FIG. 3D. The second “s” keystroke may have been included in a single packet and included in an unencrypted payload 306 as shown in FIG. 3C. The character “s” may have been included in a single packet and included in an unencrypted payload 306 as shown in FIG. 3C. The keystroke “o” may have been included in a single packet and included in an unencrypted payload 306 as shown in FIG. 3C, and the two keystrokes “r” and “d” may have been batched together into a batched packet and included in an unencrypted payload 306 as shown in FIG. 3D.

This batching of the characters of two or more characters into a single packet may both reduce the number of packets sent, and change the intervals between sending packets. Note that while FIGS. 2D and 3D show batching up to only two keystrokes into a single packet, any number such as two, three, four, five, or even thousands of keystrokes (or other user input signals) may be batched into a single packet.

In the example shown in FIG. 2D, the intervals have been changed from the original keystrokes of seven intervals of 80 milliseconds, 50 milliseconds, 150 milliseconds, 160 milliseconds, 170 milliseconds, 90 milliseconds, and 150 milliseconds, to five intervals of 130 milliseconds, 150 milliseconds, 160 milliseconds, 170 milliseconds, and 240 milliseconds. Thus, the number of packets has been reduced from the number of keystrokes, and the time intervals between sending packets have been changed from the intervals between receiving keystrokes, reducing the ability of an attacker to decipher the keystrokes based on the intervals between the packets with representations of the keystrokes.

FIG. 2E is a diagram showing keystrokes entered into the client computing device 102 and packets sent to the host computing device 104 in an example in which the client computing device 102 sends batched packets at regular intervals. In this example, the client computing device 102 may send the packets with batched representations of keystrokes every 250 milliseconds. Thus, every 250 milliseconds, the client computing device 102 may send a packet to the host computing device 104 which includes all of the characters which were typed during the previous 250 milliseconds. If no characters were typed during that time interval, then the client computing device 102 may either not send a packet, or may send a packet which indicates that no keystrokes were received (which may be similar to a dummy packet or fake event). The client computing device 102 may store and/or buffer keystrokes and/or packets for sending at the regular intervals.

In the example shown in FIG. 2E, the character “p” is sent in a single packet. The characters “a” and “s” are sent in a single packet 250 milliseconds after the packet which includes the representation of the character “p”. A packet including representations of the characters “s” and “w” is sent 250 milliseconds after the packet containing the representations of the characters “a” and “s”. A packet including representations of the characters “o” and “r” is sent 250 milliseconds after the packet containing the representations of the characters “s” and “w”. A packet including a representation of the characters “d” is sent 250 milliseconds after the packet containing the representations of the characters “w” and “o”. Thus, in this example, only five packets are sent, and they are sent with approximately equal intervals of 250 milliseconds, reducing the amount of information based upon which an attacker may attempt to decipher the keystrokes.

FIG. 2F is a diagram showing keystrokes entered into the client computing device 102 and packets sent to the host computing device 104 in an example in which the client computing device 102 sends fake or dummy packets to the host computing device 104. The client computing device 102 may introduce fake events or dummy packets to the stream of packets sent from the client computing device 102 to the host computing device 104. In this example, the client computing device 102 may send the packets which include the representations of the keystrokes immediately after, or with fixed intervals after, receiving the keystrokes, or with the same or similar latencies between receiving the keystrokes and sending the packets which include the representations of the keystrokes, but may also include fake events or dummy packets to make it more difficult for an attacker to determine which keystrokes were made. The client computing device 102 may send the fake events or dummy packets based on certain delays between keystrokes, such as when at least a threshold time interval between receiving keystrokes expires, or may simply send the fake events or dummy packets randomly. For example, the client computing device 102 may send, in response to not receiving any user input signals for at least a threshold time period, dummy packets to the host computing device 104. The dummy packets may indicate that the dummy packets do not include any information to be processed by the host computing device 104, and/or that the host computing device 104 should ignore or discard the dummy packets.

FIG. 3E is a diagram showing an unencrypted payload 306 of a fake event or a dummy packet according to an example embodiment. In this example, the unencrypted payload 306 may include the salt 316 and the flag 310. The flag 310 may indicate that the unencrypted packet 302 and the corresponding encrypted packet are fake events or dummy packets, prompting the host computing device 104 to ignore and/or discard the dummy packet(s) without storing the dummy packet. The unencrypted payload 306 may also include other fields not shown in FIG. 3E.

In the example shown in FIG. 2F, the client computing device 102 has sent fake events or dummy packets between sending packets representing the two “s” keystrokes, between sending packets representing the second “s” and the “w” keystrokes, between sending the “w” and the “o”, and has sent a fake event or dummy packet between sending the “r” and the “d”. Thus, instead of sending eight packets with seven intervals of 80 milliseconds, 50 milliseconds, 150 milliseconds, 160 milliseconds, 170 milliseconds, 90 milliseconds, and 150 milliseconds which would correspond to the received keystrokes, the client computing device 102 has sent twelve packets with eleven intervals of 80 milliseconds, 50 milliseconds, 90 milliseconds, 60 milliseconds, 100 milliseconds, 60 milliseconds, 100 milliseconds, 70 milliseconds, 90 milliseconds, 80 milliseconds, and 70 milliseconds. This increase in the number of packets sent, and change of the intervals between the packets, may make it difficult for an attacker to determine the keystrokes of the user into the client computing device 102 based on the intervals between the packets.

While this description described, and FIGS. 2A-2F showed, techniques including changing the intervals between packets, batching packets, and introducing fake events by sending dummy packets, these techniques may be combined. For example, the client computing device 102 may both change the intervals and batch packets, both change the intervals and send dummy packets, batch packets and send dummy packets, or change the intervals, batch packets, and send dummy packets, according to example embodiments.

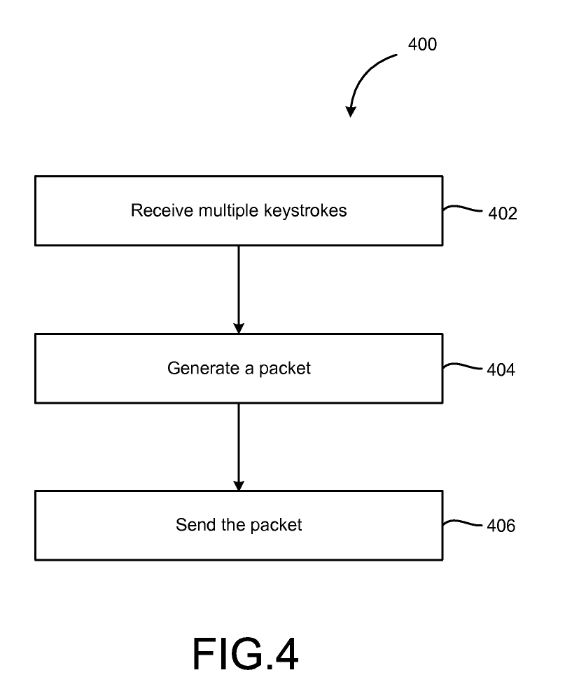

FIG. 4 is a flowchart showing a method 400 according to an example embodiment. According to this example, the method 400 may include a client computing device 102 establishing a peer-to-peer connection with a host computing device 104 (402). The method 400 may also include receiving multiple user input signals from a user of the client computing device 102 (404). The method 400 may also include generating a packet 302, the packet 302 including representations based on at least two of the user input signals (406). The method 400 may also include sending the packet 302 to the host computing device 104 via the peer-to-peer connection (408).

According to an example embodiment, the packet 302 may include the representations of at least two of the user input signals and times of receiving each of the at least two user input signals from the user.

According to an example embodiment, the method 400 may include the client computing device 102 presenting visual output to a user based on visual input received from the host computing device 104 via the peer-to-peer connection.

According to an example embodiment, the method 400 may include the client computing device 102 repeatedly performing the receiving, generating, and sending multiple times, the repeated performances of generating including generating packets with representations of different numbers of user input signals.

According to an example embodiment, the generating the packet 302 (404) may include generating the packet 302, the packet 302 including representations of a random or pseudorandom number of received user input signals.

According to an example embodiment, the method 400 may include the client computing device 102 encrypting the packet 302. The sending the packet 302 (408) may include sending the encrypted packet 302, 308 to the host computing device 104.

According to an example embodiment, the method 400 may include the client computing device 102 adding random symbols (e.g. salt 316) to the packet 302 before encrypting the packet 302, 308.

According to an example embodiment, the method 400 may include the client computing device 102 sending at least one dummy packet 302 to the host computing device 104, the dummy packet 302 indicating that the host computing device 104 should discard the dummy packet 302.

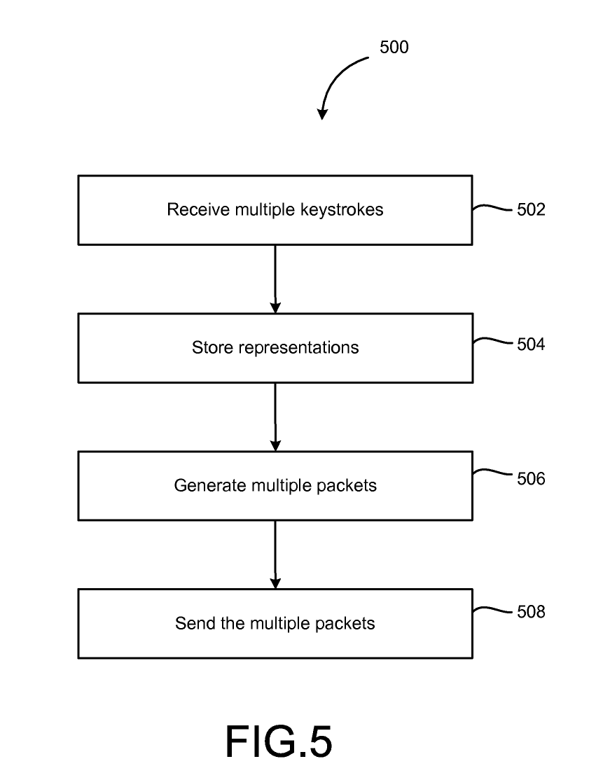

FIG. 5 is a flowchart showing a method 500 according to another example embodiment. The method 500 may include a client computing device 102 establishing a peer-to-peer connection with a host computing device 104 (502). The method 502 may also include receiving multiple user input signals from a user of the client computing device 102 (504). The method 500 may also include storing representations of the multiple user input signals (506). The method 500 may also include generating multiple packets 302, the multiple packets 302 including the representations of the multiple user input signals (508). The method 500 may also include sending, via the peer-to-peer connection, the multiple packets 302 to the host computing device 104 with intervals between sending times of the multiple packets 302 which are different than intervals between receiving the multiple user input signals from the user (510).

According to an example embodiment, the storing the representations of the multiple user input signals (506) may include storing the multiple packets 302 which include the representations of the multiple user input signals.

According to an example embodiment, the multiple packets 302 may include the representations of the multiple user input signals and times of receipt of the multiple user input signals.

According to an example embodiment, each of the multiple packets 302 may include representations of a random or pseudorandom number of the received user input signals.

According to an example embodiment, the sending the multiple packets 302 (510) may include sending the multiple packets 302 to the host computing device 104 with approximately uniform intervals between sending times of the multiple packets 104.

According to an example embodiment, the sending the multiple packets 302 (510) may include determining intervals between sending times of the multiple packets 302 by adding or subtracting random or pseudorandom time intervals to or from the intervals between receiving the multiple user input signals from the user, and sending the multiple packets 302 to the host computing device 104 with the determined intervals between sending times.

According to an example embodiment, the sending the multiple packets 302 (510) may include determining an average interval between receiving user input signals, storing intervals between receipt of the user input signals, modifying the stored intervals by increasing or decreasing the stored intervals toward the average interval, and sending the multiple packets 302 to the host computing device 104 with delays in sending times based on the modified intervals.

According to an example embodiment, the method 500 may include the client computing device 102 presenting visual output to a user based on visual input received from the host computing device 104 via the peer-to-peer connection.

According to an example embodiment, the method 500 may also include the client computing device encrypting the multiple packets 302. The sending the multiple packets (510) may include sending the multiple packets 302, 308 to the host computing device 104 after encrypting the multiple packets 302.

According to an example embodiment, the method 500 may also include the client computing device 102 adding random symbols (e.g. salt 316) to the multiple packets 302 before encrypting the multiple packets 302.

According to an example embodiment, the method 500 may also include the client computing device 102 sending dummy packets 302 to the host computing device 104, the dummy packets 302 indicating that the dummy packets 302 do not include any information to be processed by the host computing device 104.

According to an example embodiment, the method 500 may also include the client computing device 102 sending, in response to not receiving any user input signals for at least a threshold time period, dummy packets 302 to the host computing device 104, the dummy packets 302 indicating that the dummy packets 302 do not include any information to be processed by the host computing device 104.

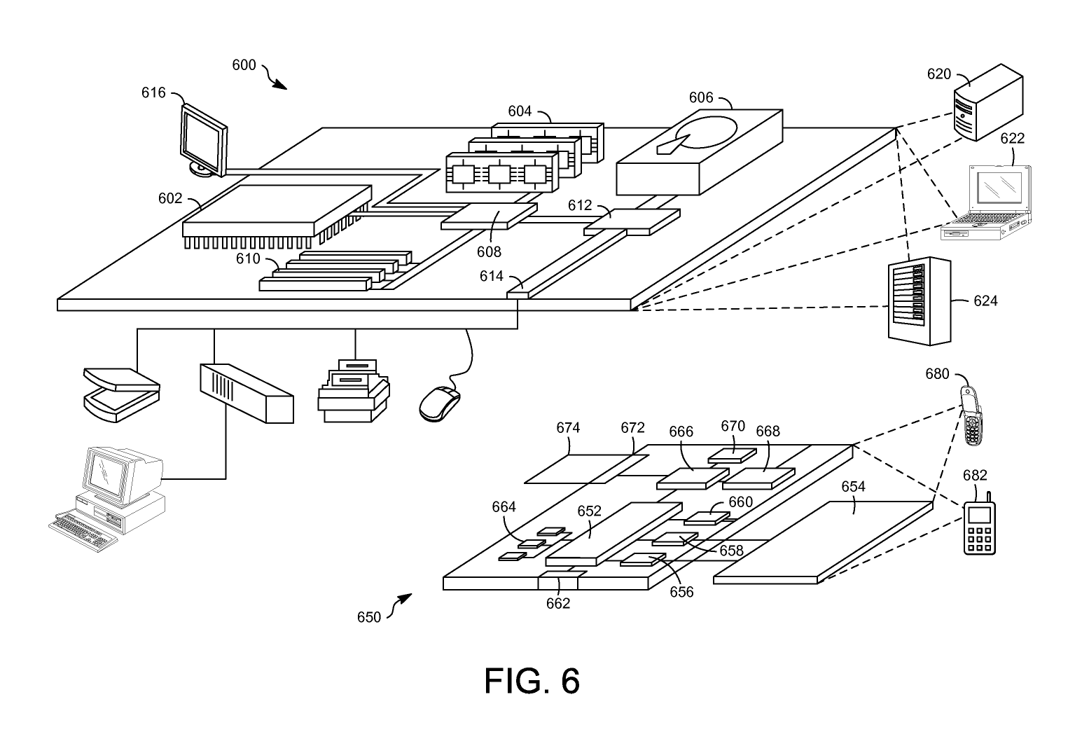

FIG. 6 shows an example of a generic computer device 600 and a generic mobile computer device 650, which may be used with the techniques described here. According to an example embodiment, the host computing device 104 may include some or all of the features of the generic computing device 600, and/or the client computing device 102 may include some or all of the features of the generic mobile computer device 650. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low-speed controller 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high-speed controller 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 600, while the low-speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing devices 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A non-transitory computer-readable storage medium storing instructions thereon that when executed cause a client computing device to perform at least the following:
receive multiple input signals at the client computing device;
generate a random or pseudorandom number n;
generate a packet, the packet including representations based on n of the multiple input signals and times of receiving each of the n input signals;
send, via a network, the packet to a host computing device;
receive, via the network, video input from the host computing device; and
present, based on the received video input, visual representations of the n input signals, the visual representations of the n input signals having same intervals as the received n input signals.

2. (canceled)

3. (canceled)

4. The storage medium of claim 1, wherein the instructions cause the client computing device to repeatedly perform the receiving, generating the random or pseudorandom number n, generating the packet, sending, receiving, and presenting multiple times, the repeated performances of generating including generating packets with representations of different numbers of input signals.

5. (canceled)

6. The storage medium of claim 1, wherein the instructions cause the client computing device to:
encrypt the packet,
wherein the sending the packet includes sending the encrypted packet to the host computing device.

7. The storage medium of claim 6, wherein the instructions cause the client computing device to add random symbols to the packet before encrypting the packet, the random symbols being generated by the client computing device.

8. The storage medium of claim 1, wherein the instructions further cause the client computing device to send at least one dummy packet to the host computing device, the dummy packet indicating that the host computing device should discard the dummy packet.

9. A non-transitory computer-readable storage medium storing instructions thereon that when executed cause a client computing device to perform at least the following:
establish a peer-to-peer connection with a host computing device;
receive multiple input signals at the client computing device;
store representations of the multiple input signals;
generate multiple packets, the multiple packets including the representations of the multiple input signals and times of receiving each of the multiple input signals;
generate random or pseudorandom time intervals;
determine time intervals between sending times of the multiple packets by adding or subtracting the generated random or pseudorandom time intervals to or from the intervals between receiving the multiple input signals;
send, via the peer-to-peer connection, the multiple packets to the host computing device with the determined time intervals between sending times;
receive, via the peer-to-peer connection, video input from the host computing device; and
present, based on the received video input, visual representations of the input signals, the visual representations of the input signals having same time intervals as the received multiple input signals.

10. The storage medium of claim 9, wherein the storing the representations of the multiple input signals includes storing the multiple packets which include the representations of the multiple input signals.

11. (canceled)

12. The storage medium of claim 9, wherein each of the multiple packets includes representations of a random or pseudorandom number of the received input signals, the random or pseudorandom number being determined by the client computing device.

13. (canceled)

14. (canceled)

15. (canceled)

16. (canceled)

17. The storage medium of claim 9, wherein the instructions further cause the client computing device to:
encrypt the multiple packets,
wherein the sending the multiple packets includes sending the multiple packets to the host computing device after encrypting the multiple packets.

18. The storage medium of claim 17, wherein the instructions cause the client computing device to add random symbols to the multiple packets before encrypting the multiple packets, the random symbols being generated by the client computing device.

19. The storage medium of claim 9, wherein the instructions further cause the client computing device to send dummy packets to the host computing device, the dummy packets indicating that the dummy packets do not include any information to be processed by the host computing device.

20. The storage medium of claim 9, wherein the instructions further cause the client computing device to send, in response to not receiving any user input signals for at least a threshold time period, dummy packets to the host computing device, the dummy packets indicating that the dummy packets do not include any information to be processed by the host computing device.

21. A non-transitory computer-readable storage medium storing instructions thereon that when executed cause a client computing device to perform at least the following:
generate multiple packets, the multiple packets including representations of multiple input signals;
generate random or pseudorandom time intervals;
determine time intervals between sending times of the multiple packets by adding or subtracting the generated random or pseudorandom time intervals to or from time intervals between receiving the multiple input signals;
generate multiple packets, the multiple packets including the representations of the multiple input signals and times of receiving each of the multiple input signals;
send, via a network, the multiple packets to a host computing device with the determined time intervals between sending times;
receive, via the network, video input from the host computing device; and
present, based on the received video input, visual representations of the input signals, the visual representations of the input signals having same time intervals as the intervals between receiving the multiple input signals.

22. (canceled)

23. The storage medium of claim 21, wherein each of the multiple packets includes representations of a random or pseudorandom number of the received input signals, the random or pseudorandom number being determined by the client computing device.

24. The storage medium of claim 1, wherein the instructions are further configured to cause the client computing device to:
establish a peer-to-peer connection with the host computing device,
wherein the sending the packet includes sending the packet to the host computing device via the peer-to-peer connection.
